(19) United States
(12) Patent Application Publication
(10) Pub. No.: US 2026/0178520 A1
(43) Pub. Date: Jun. 25, 2026

(54) ETHERNET STORAGE SYSTEM

(71) Applicant: Dell Products L.P., Round Rock, TX (US)

(72) Inventors: Raja Sathianarayan Jayakumar, Fremont, CA (US); Colin Montgomery, Mountain View, CA (US); Kevin Warren Mundt, Austin, TX (US); Stephen Strickland, Foxborough, MA (US); Per Henrik Fremrot, Novato, CA (US)

(21) Appl. No.: 18/991,971

(22) Filed: Dec. 23, 2024

(51) Int. Cl. G06F 13/16; G06F 13/40

(52) U.S. Cl. CPC G06F 13/1689; G06F 13/4027

(57) ABSTRACT

An Ethernet storage system includes a first networking device, a plurality of storage subsystems, and a first Input/Output (IO) module that is coupled to the first networking device and the plurality of storage subsystems. The first IO module includes a plurality of first retimer devices that each couple a respective subset of the plurality of storage subsystems to the first networking device. Each of the plurality of first retimer devices receives Ethernet communications from at least one of the subset of the plurality of storage subsystems coupled to that first retimer device, and performs retimer operations on the Ethernet communications received from the at least one of the subset of the plurality of storage subsystems coupled to that first retimer device to transmit the Ethernet communications to the first networking device.

### BACKGROUND

The present disclosure relates generally to information handling systems, and more particularly to Ethernet storage systems included in and/or used by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handlings systems such as, for example, server devices, desktop computing devices, laptop/notebook computing devices, tablet computing devices, mobile phones, and/or other computing devices known in the art, sometimes store their data in network-connected storage systems. Conventionally, such network-connected storage systems have been provided by Just a Bunch Of Drives (JBOD) storage systems that utilized Hard Disk Drive (HDD) storage devices, Serial Attached Small Computer System Interface (SCSI) (SAS) storage devices, and/or Serial Advanced Technology Attachment (SATA) storage devices that are connected to a network using Direct Attach Storage (DAS) technologies such as SAS or SATA, Network Attached Storage (NAS) technologies, Storage Area Network (SAN) technologies such as Fibre Channel (FC) or Internet SCSI (iSCSI), and/or other JBOD network connection subsystems known in the art. Furthermore, with the advent of Solid-State Drive (SSD) storage devices such as Non-Volatile Memory express (NVMe) storage devices, Just a Bunch Of Flash (JBOF) storage systems have been developed that connect NVMe storage devices to a network using Peripheral Component Interconnect express (PCIe) direct-connect technologies and/or other JBOF network connection subsystems known in the art.

However, Ethernet Bunch Of Flash (EBOF) storage systems have been developed that connect the NVMe storage devices discussed above to an Ethernet network using NVMe over Fabrics (NVMe-oF) technologies. As will be appreciated by one of skill in the art in possession of the present disclosure, NVMe storage devices utilize PCIe communication technologies, and require NVMe-to-Ethernet protocol conversions to provide the EBOF storage system. In conventional EBOF storage systems, such NVMe-to-Ethernet protocol conversions are provided for each NVMe storage device in the conventional EBOF storage system via a “paddleboard” that is connected to the PCIe interface on that NVMe storage device and that includes an NVMe-to-Ethernet bridge chip that is configured to receive NVMe communications from the NVMe storage device and perform NVMe-to-Ethernet protocol conversions to output redundant Ethernet communications to a pair of redundant Input/Output (IO) modules in the EBOF storage system that are each coupled to a respective Top Of Rack (TOR) switch device, as well as to receive Ethernet communications from either of the pair of redundant IO modules and perform Ethernet-to-NVMe conversions to output NVMe communications to the NVMe storage device.

Each of the conventional IO modules in the conventional EBOF storage system discussed above is provided with Ethernet switch chip that is connected to all of the NVMe storage devices in the conventional EBOF system (via the NVMe-to-Ethernet bridge chip on the paddleboard connected to that NVMe storage device) and to the respective TOR switch device discussed above (e.g., via one or more of a plurality of TOR switch device connectors on that conventional IO module). Furthermore, each conventional IO module in that conventional EBOF storage system is also provided with a System on Chip (SoC) and corresponding memory system that provides a Networking Operating System (NOS) for the Ethernet switch chip.

As will be appreciated by one of skill in the art in possession of the present disclosure, the Ethernet switch chip in conventional IO modules of conventional EBOF storage systems allows a single TOR switch device connector on the conventional IO module to be coupled to a single TOR switch device port on a TOR switch device in order to couple the NVMe storage devices to which it is connected to that TOR switch device, but such a configuration will likely result in a communications bottleneck, particularly as the number of NVMe storage devices in the conventional EBOF storage system increases. As such, the TOR switch device connectors on the conventional IO modules of conventional EBOF storage systems are typically connected to a plurality of TOR switch device ports on a TOR switch device, particularly in situations in which the performance of the conventional EBOF storage system is a concern (e.g., situations in which relatively high bandwidths are required for communications with the NVMe storage devices).

The inventors of the present disclosure have recognized that the configuration of conventional EBOF storage systems discussed above essentially provides two “switch devices” in series, as the switching functionality of the TOR switch device is relatively architecturally identical to that provided in the IO module (i.e., each is provided by an Ethernet switch chip/NOS like that described above for the IO module). As will be appreciated by one of skill in the art in possession of the present disclosure, such a configuration creates an additional network “hop” that adds to the latency of each NVMe storage device data path, and provides a relatively costly EBOF storage system due to its use of two Ethernet switch chips, two SoCs and corresponding memory systems, licensing costs for two NOSs, and/or other costs that would be apparent to one of skill in the art in possession of the present disclosure.

Such costs are particularly troublesome in the situations discussed above in which the performance of the EBOF storage system is a concern, as EBOF storage systems with relatively high performance requirements will result in an attempt to provide an IO-module-to-TOR-switch-device bandwidth between the IO module and the TOR switch device that is as close as possible to the IO-module-to-NVMe-storage-device bandwidth between the IO module and the NVMe storage devices, and in such a situation the Ethernet switch chip in the IO module is not utilized to perform most (if not all) of the switching functionality that it is capable of. Furthermore, many users limit the switch devices they utilize in their networks to approved switch devices type(s) (e.g., users often only deploy switch devices provided by a single switch device provider in their network), and thus those users may choose to not deploy an EBOF storage system in their network if its IO modules are provided with a “switch device” that is not an approved switch device type.

Accordingly, it would be desirable to provide an Ethernet storage system that addresses the issues discussed above.

### SUMMARY

According to one embodiment, an Input/Output (IO) module includes an Input/Output (IO) module chassis; a plurality of first networking device connectors that are included on the IO module chassis; a plurality of storage connectors that are included on the IO module chassis; and a plurality of first retimer devices that are included on the IO module chassis and that each couple a respective subset of the plurality of storage connectors to a respective subset of the plurality of first networking device connectors, wherein each of the plurality of first retimer devices is configured to: receive Ethernet communications via at least one of the subset of the plurality of storage connectors coupled to that first retimer device; and perform retimer operations on the Ethernet communications received from the at least one of the subset of the plurality of storage connectors coupled to that first retimer device to transmit the Ethernet communications via at least one of the subset of the plurality of first networking device connectors coupled to that first retimer device.

### BRIEF DESCRIPTION OF THE DRAWINGS

FIG. 1 is a schematic view illustrating an embodiment of an Information Handling System (IHS).

FIG. 2 is a schematic view illustrating an embodiment of an Ethernet storage system that may be provided according to the teachings of the present disclosure.

FIG. 3 is a schematic view illustrating an embodiment of a networking device that may be included in the Ethernet storage system of FIG. 2.

FIG. 4 is a schematic view illustrating an embodiment of an IO module that may be included in the Ethernet storage system of FIG. 2.

FIG. 5 is a schematic view illustrating an embodiment of a storage subsystem that may be included in the Ethernet storage system of FIG. 2.

FIG. 6 is a flow chart illustrating an embodiment of a method for storing data in a storage system using an Ethernet network.

FIG. 7A is a schematic view illustrating an embodiment of the Ethernet storage system of FIG. 2 operating during the method of FIG. 6.

FIG. 7B is a schematic view illustrating an embodiment of the IO module of FIG. 4 operating during the method of FIG. 6.

FIG. 7C is a schematic view illustrating an embodiment of the storage subsystem of FIG. 5 operating during the method of FIG. 6.

FIG. 8A is a schematic view illustrating an embodiment of the storage subsystem of FIG. 5 operating during the method of FIG. 6.

FIG. 8B is a schematic view illustrating an embodiment of the IO module of FIG. 4 operating during the method of FIG. 6.

FIG. 8C is a schematic view illustrating an embodiment of the Ethernet storage system of FIG. 2 operating during the method of FIG. 6.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

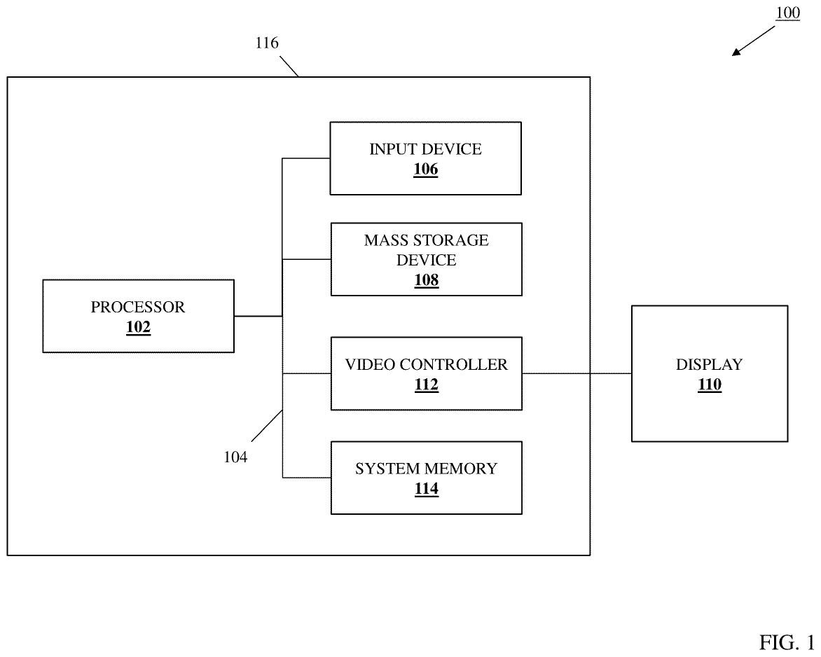

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

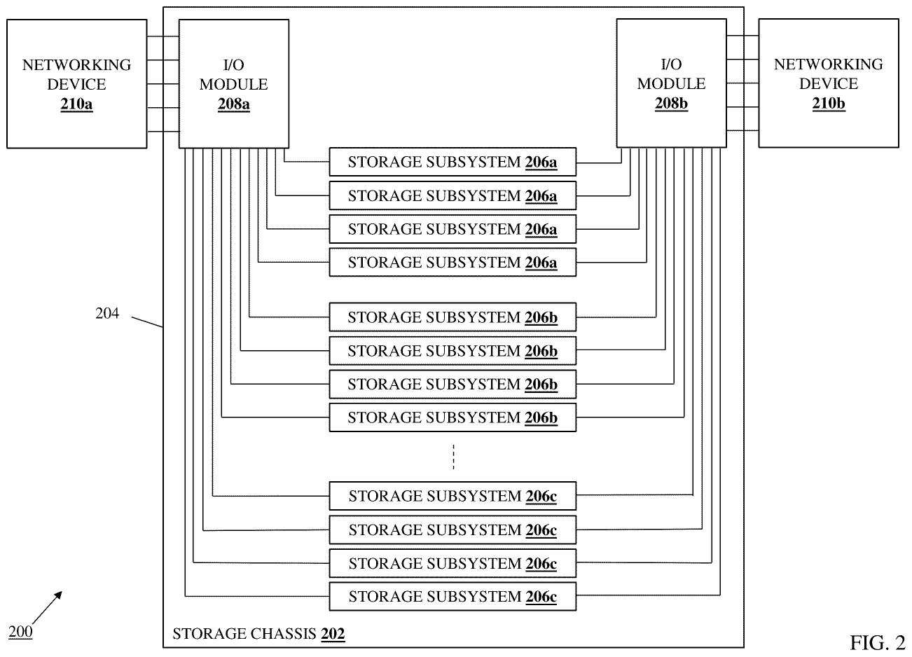

Referring now to FIG. 2, an embodiment of an Ethernet storage system 200 is illustrated that may be provided according to the teachings of the present disclosure. As will be appreciated by one of skill in the art in possession of the present disclosure, the examples provided below of the Ethernet storage system 200 describe an Ethernet Bunch Of Flash (EBOF) storage system, but as discussed below other Ethernet storage systems may be provided according to the teachings of the present disclosure while remaining within its scope. In the illustrated embodiment, the Ethernet storage system 200 includes a storage chassis 202 that houses components of the Ethernet storage system 200, only some of which are illustrated a described below. For example, the storage chassis 202 may be provided by an EBOF storage chassis that is configured to be positioned in a rack, although other storage chassis will fall within the scope of the present disclosure as well.

In the illustrated embodiments, the storage chassis 202 houses a plurality of storage devices 206a, 206b, and up to 206c. In the specific examples provided below, the Ethernet storage system 200 includes twenty storage subsystems 206a-206c that are divided up into groups of four storage subsystems each (e.g., the first group of the four storage subsystems 206a, the second group of the four storage subsystems 206b, and up to the fifth group of the four storage subsystems 206c) based on the specific connectivity configurations of the Ethernet storage system 200 in those examples, but one of skill in the art in possession of the present disclosure will appreciate how different numbers of storage subsystems and/or different connectivity configurations will fall within the scope of the present disclosure as well. The storage subsystems 206a-206c are discussed in further detail below, but one of skill in the art in possession of the present disclosure will appreciate that, in embodiments in which the Ethernet storage system 200 is provided by the EBOF storage system discussed above, each of the storage subsystems 206a-206c may include a respective NVMe storage device.

In the illustrated embodiments, the storage chassis 202 also houses a pair of IO modules 208a and 208b, each of which is connected to each of the plurality of storage subsystems 206a-208c, and one of skill in the art in possession of the present disclosure will appreciate how the pair of IO modules 208a and 208b may operate to provide redundancy for the Ethernet storage system 200 by providing independent connectivity to each of the plurality of storage subsystems 206a-206c. As such, while not described in detail, one of skill in the art in possession of the present disclosure will appreciate how one of the IO modules 208a and 208b may provide a “primary” IO module that is configured to provide access to the storage subsystems 206a-206c, and the other of the IO modules 208a and 208b may provide a “secondary” IO module that is configured to provide access to the storage subsystems 206a-206c in the event the “primary” IO module becomes unavailable, using any of a variety of redundancy configuration techniques that would be apparent to one of skill in the art in possession of the present disclosure.

In the illustrated embodiments, a networking device 210a and 210b are connected to each of the pair of IO modules 208a and 208b, respectively, in the storage chassis 202. In an embodiment, either of the networking devices 210a and 210b may be provided by the IHS 100 discussed above with reference to FIG. 1 and/or may include some or all of the components of the IHS 100, and in specific examples, may each be provided by a respective Top Of Rack (TOR) switch device that may be included in a rack with the storage chassis 202 (e.g., an EBOF storage chassis), although one of skill in the art in possession of the present disclosure will appreciate how other networking devices will fall within the scope of the present disclosure as well.

Similarly as described above, in the specific examples provided below, each networking device 210a and 210b is illustrated as including five connections to its connected IO module 208a and 208b, respectively, based on the specific connectivity configurations of the Ethernet storage system 200 in those example (e.g., when the Ethernet storage system 200 includes twenty storage subsystems 206a-206c and respective groups of four storage subsystems are connected to the networking devices 210a and 210b via each of the five connections between the IO modules 208a and 208b and those networking devices 210a and 210b, respectively), but one of skill in the art in possession of the present disclosure will appreciate how different connectivity configurations will fall within the scope of the present disclosure as well. As such, while a specific Ethernet storage system 200 has been illustrated and described, one of skill in the art in possession of the present disclosure will appreciate how the Ethernet storage system of the present disclosure may include a variety of components and/or component configurations that will fall within the scope of the present disclosure as well.

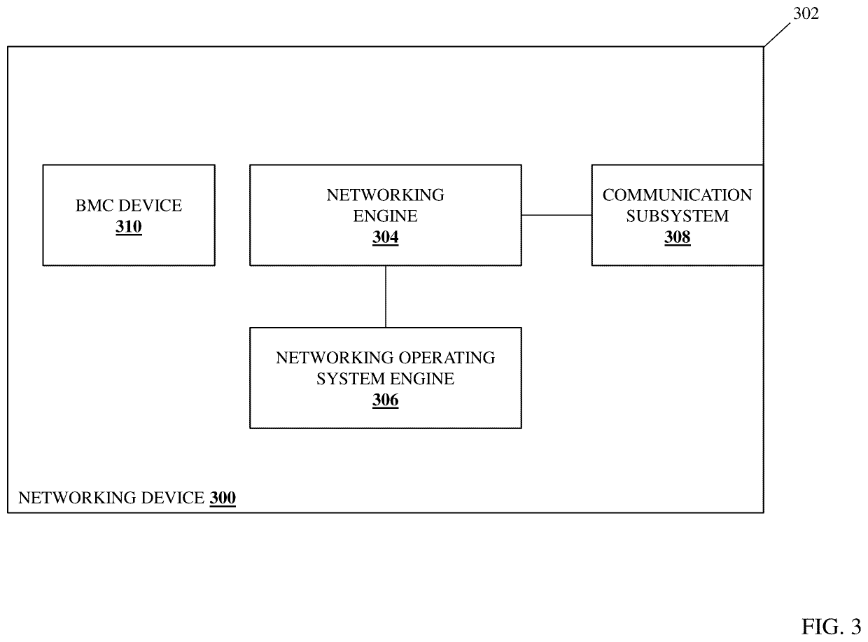

Referring now to FIG. 3, an embodiment of a networking device 300 is illustrated that may provide either or each of the networking devices 210a and 210b in the Ethernet storage system 200 discussed above with reference to FIG. 2. As such, the networking device 300 may be provided by the IHS 100 discussed above with reference to FIG. 1 and/or may include some or all of the components of the IHS 100, and in specific examples may be provided by a TOR switch device. However, while illustrated and discussed as being provided by a TOR switch device, one of skill in the art in possession of the present disclosure will recognize that the functionality of the networking device 300 discussed below may be provided by other devices that are configured to operate similarly as the networking device 300 discussed below.

In the illustrated embodiment, the networking device 300 includes a chassis 302 that houses the components of the networking device 300, only some of which are illustrated and described below. For example, the chassis 302 may house a networking processing system (not illustrated, but which may be similar to the processor 102 discussed above with reference to FIG. 1 such as, for example, an Ethernet switch chip) and a networking memory system (not illustrated, but which may be similar to the memory 114 discussed above with reference to FIG. 1) that is coupled to the networking processing system and that includes instructions that, when executed by the networking processing system, cause the networking processing system to provide a networking engine 304 that is configured to perform data communication routing and/or any other functionality of the networking engines and/or networking devices discussed below.

Furthermore, the chassis 302 may also house a networking operating system processing system (not illustrated, but which may be similar to the processor 102 discussed above with reference to FIG. 1 such as, for example, a System on Chip (SoC)) and a networking operating system memory system (not illustrated, but which may be similar to the memory 114 discussed above with reference to FIG. 1) that is coupled to the networking operating system processing system and that includes instructions that, when executed by the networking operating system processing system, cause the networking operating system processing system to provide an networking operating system engine 306 that is configured to provide an Networking Operating System (NOS) for the networking processing system (e.g., the Ethernet switch chip) discussed above and/or perform the functionality of the networking operating system engines and/or networking devices discussed below.

The chassis 302 may also house a communication system 308 that is coupled to the networking engine 304 (e.g., via a coupling between the communication system 308 and the networking processing system) and that may include networking ports and/or any other networking communication components that would be apparent to one of skill in the art in possession of the present disclosure. The chassis 302 may also house a Baseboard Management Controller (BMC) device 310 that one of skill in the art in possession of the present disclosure will appreciate may be coupled to hardware in the networking device 300 and configured for use in remote management of the networking device 300, environmental monitoring for the networking device 300, event logging for the networking device 300, security operations for the networking device 300, firmware management for the networking device 300, and/or any other BMC operations that would be apparent to one of skill in the art in possession of the present disclosure. However, while a specific networking device 300 has been illustrated and described, one of skill in the art in possession of the present disclosure will recognize that networking devices (or other devices operating according to the teachings of the present disclosure in a manner similar to that described below for the networking device 300) may include a variety of components and/or component configurations for providing conventional networking device functionality, as well as the Ethernet storage functionality discussed below, while remaining within the scope of the present disclosure as well.

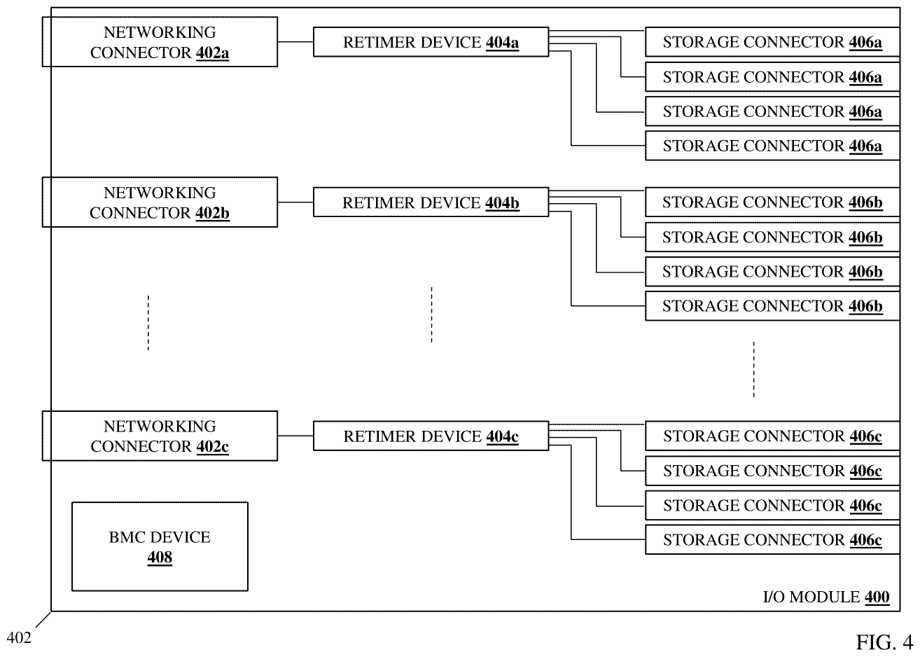

Referring now to FIG. 4, an embodiment of an IO module 400 is illustrated that may provide either or each of the IO modules 208a and 208b in the Ethernet storage system 200 discussed above with reference to FIG. 2. In the illustrated embodiment, the IO module 400 includes a chassis 402 that houses the components of the IO module 400, only some of which are illustrated and described below. In the illustrated example, a plurality of networking connectors 402a, 402b, and up to 402c are included on and accessible on the chassis 402. Similarly as described above, in the specific examples provided below, each IO module 400 is described as including five networking connectors 402a-402c (to connect to the networking device 210a or 210b as discussed above with reference to FIG. 2) based on the specific connectivity configurations of the Ethernet storage system 200 in those examples, but one of skill in the art in possession of the present disclosure will appreciate how different connectivity configurations will fall within the scope of the present disclosure as well.

In the illustrated embodiment, a retimer device 404a, 404b, and up to 404c is coupled to each of the networking connectors 402a, 402b, and up to 402c, respectively, and one of skill in the art in possession of the present disclosure will appreciate how each retimer device 404a-404c may include a Clock Data Recovery (CDR) circuit, a Decision Feedback Equalizer (DFE), equalization stage components, and/or other retimer components that are configured to extract an embedded clock signal from a data communication, recover data in the data communication, retransmit a copy of that data communication using a new clock signal, and/or perform any other retimer operations that one of skill in the art in possession of the present disclosure will recognize operate to maintain integrity of the data communications transmitted via the retimer device. Similarly as described above, in the specific examples provided below, each IO module 400 is described as including five retimer devices 404a-404c (connected to the five networking connectors 402a-402c) based on the specific connectivity configurations of the Ethernet storage system 200 in those example, but one of skill in the art in possession of the present disclosure will appreciate how different connectivity configurations will fall within the scope of the present disclosure as well.

In the illustrated embodiments, the IO module 400 includes a plurality of storage device connectors 406a that are coupled to the retimer device 404a, a plurality of storage device connectors 406b that are coupled to the retimer device 404b, and up to a plurality of storage device connectors 406c that are coupled to the retimer device 404c. In the specific examples provided below, the IO module 400 includes twenty storage connectors 406a-406c that are divided up into groups of four storage connectors each (e.g., the first group of the four storage connectors 406a coupled to the retimer device 404a, the second group of the four storage connectors 406b coupled to the retimer device 404b, and up to the fifth group of the four storage connectors 406c coupled to the retimer device 404c) based on the specific connectivity configurations of the Ethernet storage system 200 in those examples, but one of skill in the art in possession of the present disclosure will appreciate how different numbers of storage connectors and/or different connectivity configurations will fall within the scope of the present disclosure as well.

In a specific example, each of the retimer devices 404a, 404b, and up to 404c may be configured to receive four inputs (e.g., four Small Form-factor Pluggable 112 (SFP112) inputs) via their respective group of four connected storage connectors 406a, 40b, and up to 406c, and aggregate those four inputs to provide a single output (e.g., a Quad Small Form-factor Pluggable 112 (QSFP) output) to their respective connected networking connectors 402a, 402b, and up to 402c. However, in another non-illustrated example, each of the retimer devices 404a, 404b and up to 404c may be configured to receive eight inputs (e.g., eight SFP112 inputs) via a respective group of eight connected storage connectors, and aggregate those eight inputs to provide a single output (e.g., an Optical Small Form-factor Pluggable 112 (OSFP) output, a Quad Small Form-factor Pluggable-Double Data (QSFP-DD) output, etc.) to their respective connected networking connectors. However, while two specific examples have been provided, one of skill in the art in possession of the present disclosure will appreciate how a variety of aggregations may be provided via the retimer devices 404a-404c while remaining within the scope of the present disclosure as well.

As will be appreciated by one of skill in the art in possession of the present disclosure, the Ethernet storage system 200 may provide an IO-module-to-networking-device bandwidth between the IO module 208a and the networking device 210a that is equal to an IO-module-to-storage-subsystem bandwidth between the IO module 208a and the plurality of storage subsystems 206a-206c. Similarly, the Ethernet storage system 200 may provide an IO-module-to-networking-device bandwidth between the IO module 208b and the networking device 210b that is equal to an IO-module-to-storage-subsystem bandwidth between the IO module 208b and the plurality of storage subsystems 206a-206c. To provide a specific example, a respective 100G coupling may be provided between each of the twenty storage subsystems 206a-206c and each of the IO modules 208a and 208b (i.e., providing an IO-module-to-storage-subsystem bandwidth of 2T), and each of the five retimer devices 404a-404c may be coupled to its four storage connectors 406a-406c via a respective 100G coupling. Each of the five retimer devices 404a-404c may then include a 400G coupling to its corresponding networking connector 402a-402c, with a respective 400G coupling provided between each of those five networking connectors 402a-402c and the networking device 210a (i.e., providing an IO-module-to-networking-device bandwidth of 2T). As such, embodiments in which redundant IO modules 208a and 208b are utilized may provide a total connectivity bandwidth of 4T.

As will be appreciated by one of skill in the art in possession of the present disclosure, the IO modules used in Ethernet storage system of the present disclosure replace the Ethernet switch chip, SoC and corresponding memory system, and NOS utilized in the conventional IO modules of conventional EBOF storage systems discussed above with the retimer devices described herein that couple the storage subsystems to the networking devices. For example, with reference to the networking device 300 of FIG. 3 and the IO module 400 of FIG. 4, a conventional IO module in a conventional EBOF storage system uses the Ethernet switch chip included in the networking engine 304, and the NOS provided by the SoC and the corresponding memory system included in the networking operating system engine 206, to connect the storage connectors 406a-406c to the networking connectors 402a-402c.

As described above, the subsequent use of that conventional IO module to connect the storage subsystems to a networking device (i.e., similarly as illustrated by the IO module 208a connecting the storage subsystems 206a-206c to the networking device 210a in FIG. 2) operates to essentially provide a pair of networking devices in series (i.e., the Ethernet switch chip and NOS provided by the SoC and corresponding memory in each of the networking device and the conventional IO module), and results in the issues discussed above. In particular, when conventional EBOF storage systems require high performance and result in an attempt to provide an IO-module-to-networking-device bandwidth between the conventional IO module and its networking device that is as close as possible to an IO-module-to-storage-subsystem bandwidth between the conventional IO module and the storage subsystems, the Ethernet switch chip in the IO module will not be utilized to perform most (if not all) of the switching functionality that it is capable of. As will be appreciated by one of skill in the art in possession of the present disclosure, the use of the retimer devices described above provides a significantly less complex, lower power, and lower cost IO module relative to such conventional IO modules, with the IO modules of the present disclosure providing particular benefits when provided in a high performance Ethernet storage system due to its configuration that equalizes its IO-module-to-networking-device bandwidth with its IO-module-to-storage-subsystem bandwidth.

However, while specific benefits of providing retimer devices in the IO module of the present disclosure between its connected storage subsystems and networking device have been described, one of skill in the art in possession of the present disclosure will appreciate how other benefits may be realized via the provisioning of switch device(s) in the IO module of the present disclosure between its connected storage subsystems and networking device in order to achieve a 1:1 bandwidth. For example, in the event a link rate between the IO module of the present disclosure and a connected storage subsystem were 100G, while the link rate between the IO module of the present disclosure and corresponding connection to the networking device were 200G, a switch device could be configured to match the bandwidth (e.g., 100G) in such a situation using half as many connections.

The chassis 402 may also house a BMC device 408 that one of skill in the art in possession of the present disclosure will appreciate may be coupled to hardware in the IO module 400 and configured for use in remote management of the IO module 400, environmental monitoring for the IO module 400, event logging for the IO module 400, security operations for the IO module 400, firmware management for the IO module 400, lifecycle management of the IO module 400, fan control for the IO module 400, inventory management for the IO module 400, storage subsystem management for storage subsystems connected to the IO module 400, and/or any other BMC operations that would be apparent to one of skill in the art in possession of the present disclosure. However, while a specific IO module 400 has been illustrated and described, one of skill in the art in possession of the present disclosure will recognize that IO modules (or other devices operating according to the teachings of the present disclosure in a manner similar to that described below for the IO module 400) may include a variety of components and/or component configurations for providing conventional IO module functionality, as well as the Ethernet storage functionality discussed below, while remaining within the scope of the present disclosure as well.

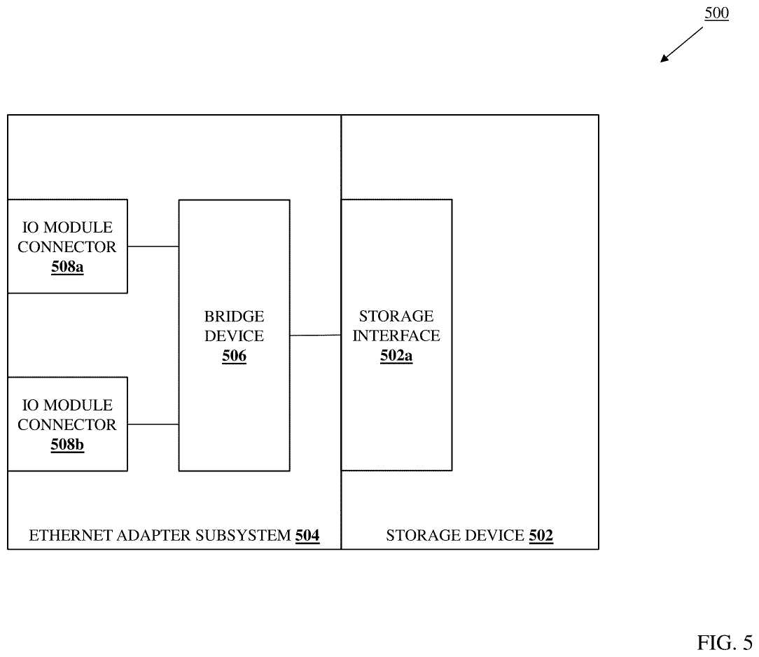

Referring now to FIG. 5, an embodiment of a storage subsystem 500 is illustrated that may provide any of the storage subsystems 206a-206c in the Ethernet storage system 200 discussed above with reference to FIG. 2. In the illustrated embodiment, the storage subsystem 500 includes a storage device 502 having a storage interface 502a. Continuing with the specific example above in which the Ethernet storage system 200 is an EBOF storage system, the storage device 502 may be provided by an NVMe storage device having a PCIe interface, although one of skill in the art in possession of the present disclosure will appreciate how a variety of storage devices having a variety of storage device interfaces will fall within the scope of the present disclosure as well.

In the illustrated embodiment, the storage subsystem 500 also includes an Ethernet adapter subsystem 504 that is coupled to the storage interface 502a on the storage device 502. For example, the Ethernet adapter subsystem 504 may be provided by a “paddleboard” and/or other Ethernet adapter subsystems that would be apparent to one of skill in the art in possession of the present disclosure. In the examples provided below, the Ethernet adapter subsystem 504 includes a bridge device 506 that is coupled to the storage interface 502a via the coupling of the Ethernet adapter subsystem 504 to the storage interface 502a on the storage device 502.

Continuing with the specific example above in which the Ethernet storage system 200 is an EBOF storage system, the bridge device 506 may be provided by a NVMe-to-Ethernet bridge device that is configured to convert between the NVMe communications and the Ethernet communications as described herein, although other bridge devices that provide other communication conversions will fall within the scope of the present disclosure as well. Furthermore, one of skill in the art in possession of the present disclosure will appreciate how the development of “native Ethernet” storage devices that are configured to generate and transmit Ethernet communications, and their use in as the storage device 502 in the storage subsystem 500, will allow the bridge device 506 to be omitted. In the illustrated example, a pair of IO module connectors 508a and 508b are included on and accessible on the chassis 502, are coupled to the bridge device 506, and are each configured to couple the storage subsystem 500 to one of the redundant IO modules 210a and 210b as described above.

As will be appreciated by one of skill in the art in possession of the present disclosure, specific embodiments of the present disclosure may provide the storage subsystem 500 using single-ported NVMe storage devices that are relatively lower cost than dual ported NVMe storage devices. Furthermore, one of skill in the art in possession of the present disclosure will appreciate how the storage subsystem 500 of the presents disclosure may operate to move the hot pluggable “point” in the Ethernet storage system of the present disclosure from a PCIe hot pluggable “point” to an Ethernet hot pluggable “point” that is designed to handle hot plug operations and hot removal operations better than PCIe technologies. However, while a specific storage subsystem 500 has been illustrated and described, one of skill in the art in possession of the present disclosure will appreciate how storage subsystems utilized in the Ethernet storage system of the present disclosure may include a variety of components and/or component configurations while remaining within the scope of the present disclosure as well.

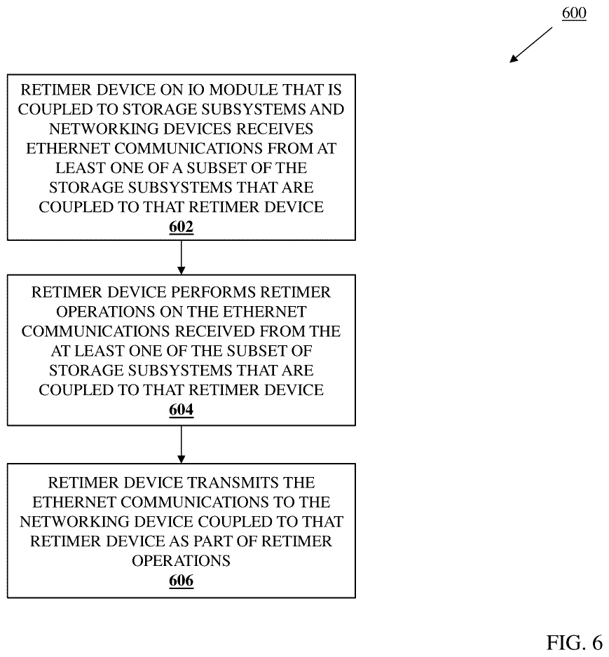

Referring now to FIG. 6, an embodiment of a method 600 for storing data in a storage system using an Ethernet network is illustrated. As discussed below, the systems and methods of the present disclosure provide retimer devices in an IO module to transmit Ethernet communications between storage subsystems and networking devices in an Ethernet storage system. For example, the Ethernet storage system of the present disclosure may include a first networking device, a plurality of storage subsystems, and a first Input/Output (IO) module that is coupled to the first networking device and the plurality of storage subsystems. The first IO module includes a plurality of first retimer devices that each couple a respective subset of the plurality of storage subsystems to the first networking device. Each of the plurality of first retimer devices receives Ethernet communications from at least one of the subset of the plurality of storage subsystems coupled to that first retimer device, and performs retimer operations on the Ethernet communications received from the at least one of the subset of the plurality of storage subsystems coupled to that first retimer device to transmit the Ethernet communications to the first networking device. As such, Ethernet storage systems may be provided with IO modules that are less complex, that use less power, and that cost less than conventional IO modules that utilize Ethernet switch chips and NOSs provided by SoCs and corresponding memory systems.

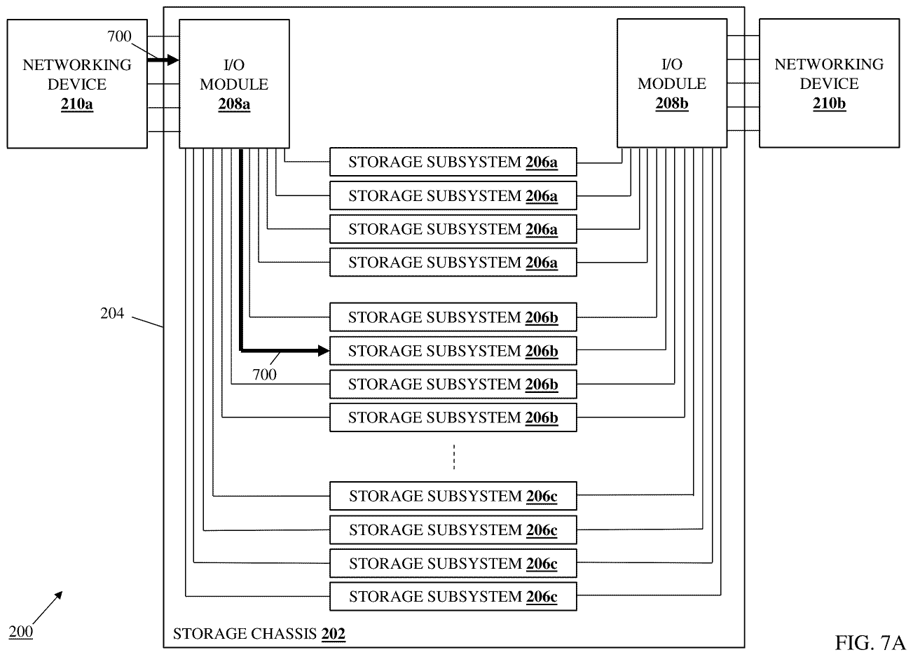

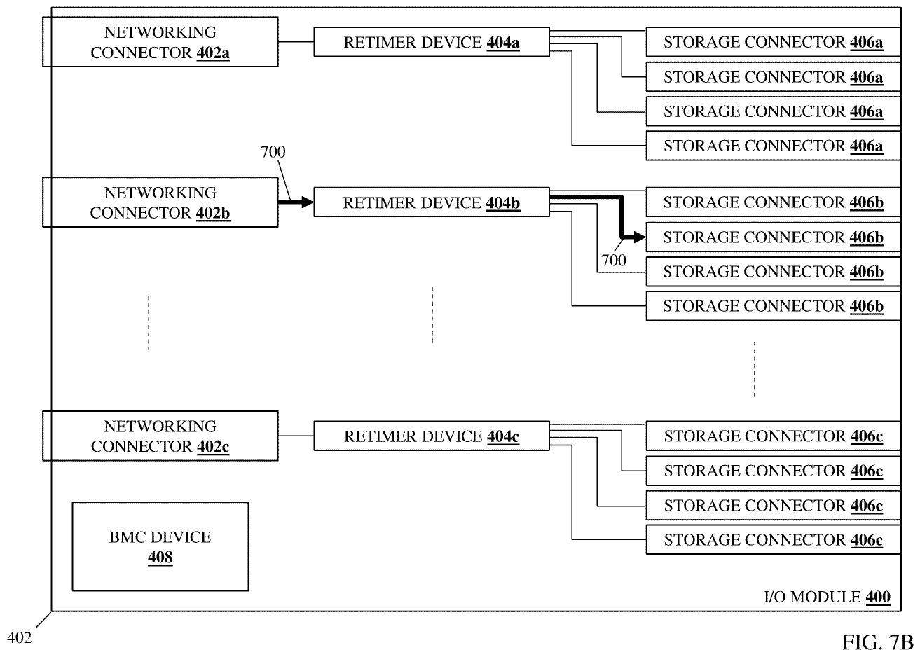

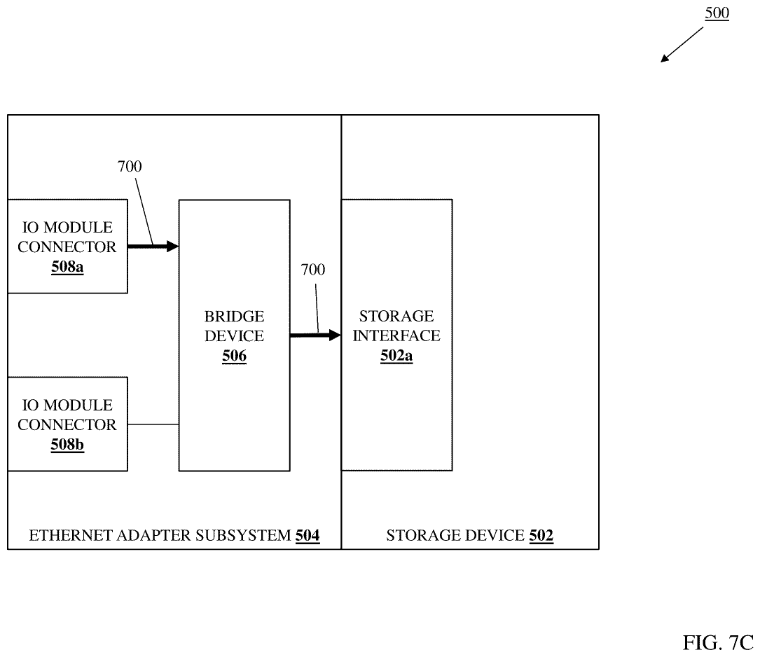

With reference to FIGS. 7A, 7B, and 7C, in some embodiments and during or prior to the method 600, the Ethernet storage system 200 may perform data request receiving operations 700 that include the networking engine 304 in the networking device 210a/300 receiving an Ethernet communication via its communication subsystem 308 (e.g., from a computing device that is coupled to the networking device 210a via a network, not illustrated) that includes a data retrieval request that provides a command to retrieve data from the Ethernet storage system 200. In the examples provided below, the command in the data retrieval request requests data stored in one of the storage subsystems 206b (e.g., the “second” storage subsystem 206b from the “top” of the group of storage subsystems 206b in FIG. 2), but one of skill in the art in possession of the present disclosure will appreciate how data may be requested from any of the storage subsystems 206a-206c similarly as described below for the storage device 206b.

With reference to FIGS. 7A and 7B, the data request receiving operations 700 by the Ethernet storage system 200 may then include the networking engine 304 in the networking device 210a/300 forwarding the Ethernet communication that includes the data retrieval request via its communication subsystem 308 and to the retimer device 404b in the IO module 208a/400 via the networking connector 402b, and the retimer device 404b in the IO module 208a/400 forwarding the Ethernet communication that includes the data retrieval request via one of the storage connectors 406b (e.g., the “second” storage connector 406b from the “top” of the group of storage connectors 406b in FIG. 7B) and to the storage subsystem 206b/500 (e.g., the “second” storage subsystem 206b from the “top” of the group of storage subsystems 206b in FIG. 7A).

As will be appreciated by one of skill in the art in possession of the present disclosure, in some embodiments the Ethernet communication that includes the data retrieval request and that is transmitted by the networking engine 304 in the networking device 210a/300 to the IO module 208a will not require the retimer device 404b described below despite the relatively long distance that Ethernet communication must travel between the networking device 210a/300 and the IO module 208a (e.g., the relatively long distance from the networking device 210a/300 and across multiple rack units in a rack via a cable to the IO module 208a as compared to the relatively short distance that Ethernet communication must travel between the IO module 208a and the storage subsystem 206b via cabling, traces, and/or other couplings in the storage chassis 202), as the Ethernet switch chip that provides the networking engine 304 will typically generate that Ethernet communication with a relatively high strength that allows the retimer device 404b to perform relatively minimal retimer operations to receive and redrive that Ethernet communication to the storage subsystem 206. However, embodiments in which the retimer device 404b performs relatively extensive retimer operations on the Ethernet communication that includes the data retrieval request will fall within the scope of the present disclosure as well.

With reference to FIG. 7C, the bridge device 506 in the storage subsystem 206b/500 (e.g., the “second” storage subsystem 206b from the “top” of the group of storage subsystems 206b in FIG. 7A) may then receive the Ethernet communication that includes the data retrieval request via the IO module connector 508a that is coupled to the storage connector 406b (e.g., the “second” storage connector 406b from the “top” of the group of storage connectors 406b in FIG. 7B), convert that Ethernet communication to a storage protocol communication that includes the data retrieval request, and then transmit the storage protocol communication that includes the data retrieval request via the storage interface 502a to a storage controller (not illustrated) in the storage device 502 in that storage subsystem 406b/500. Continuing with the example in which the Ethernet storage system 200 is an EBOF storage system and the storage device 502 in the storage subsystem 406b/500 is an NVMe storage device, the bridge device 506 may be an NVMe-to-Ethernet bridge device that converts the Ethernet communication to an NVMe communication that includes the data retrieval request, and transmits that NVMe communication via a PCIe interface that provides the storage interface 502a, although the conversion of Ethernet communications to other storage protocol communications and the transmission of those storage protocol communications via other storage interfaces will fall within the scope of the present disclosure as well.

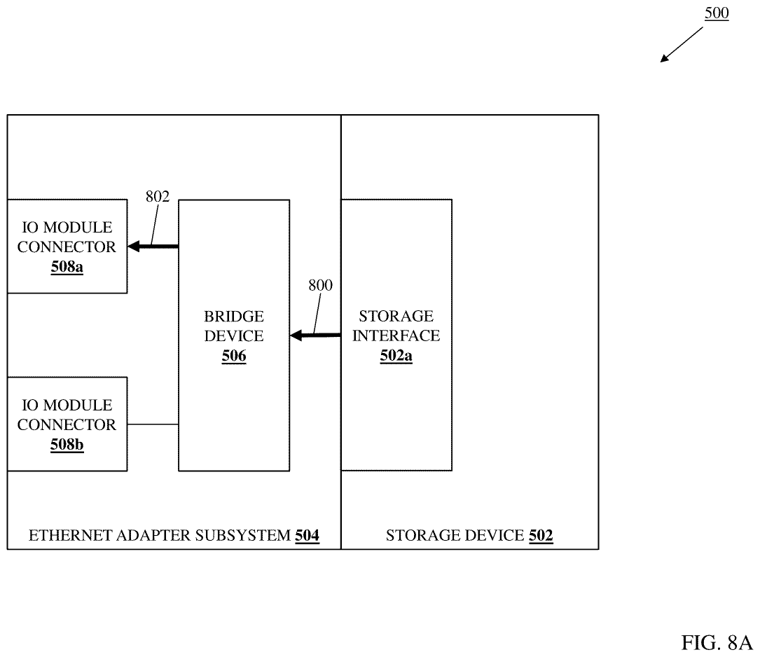

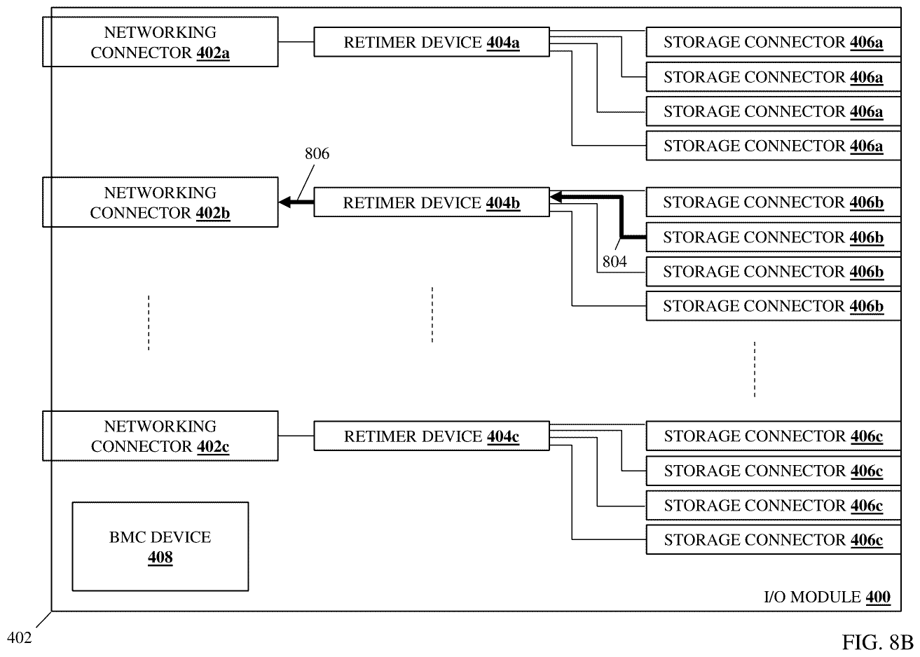

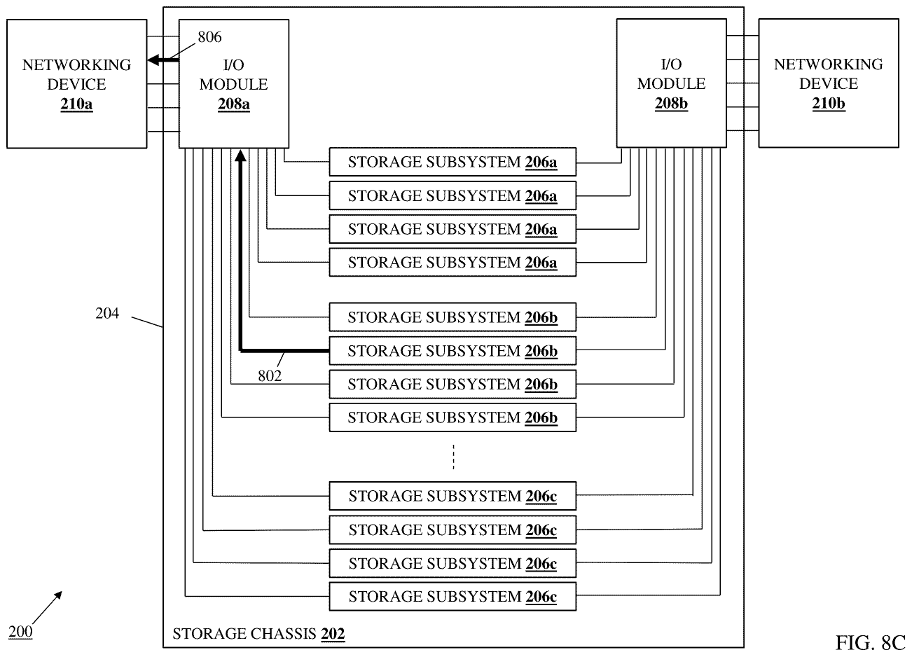

The method 600 begins at block 602 where retimer device on an IO module that is coupled to storage subsystems and networking devices receives Ethernet communications from at least one of a subset of the storage subsystems that are coupled to that retimer device. With reference to FIG. 8A, in response to receiving the storage protocol communication that includes the data retrieval request via the storage interface 502a, the storage controller in the storage device 502 in the storage subsystem 406b/500 will execute that data retrieval request to retrieve the requested data from the storage device 502, and will perform data provisioning operations 800 that include transmitting a storage protocol communication that includes that data via the storage interface 502a and to the bridge device 506. Continuing with the example in which the Ethernet storage system 200 is an EBOF storage system and the storage device 502 in the storage subsystem 406b/500 is an NVMe storage device, the storage controller in the storage device 502 may transmit an NVMe communication and includes the data retrieved from the storage device 502 via a PCIe interface that provides the storage interface 502a, although the transmission of other storage protocol communications via other storage interfaces will fall within the scope of the present disclosure as well.

With continued reference to FIGS. 8A and 8C, the bridge device 506 may then perform data communication conversion and transmission operations 802 that include converting the storage protocol communication that includes the data retrieved from the storage device 502 and that was received from the storage controller in the storage device 502 to an Ethernet communication that includes the data retrieved from the storage device 502, and transmitting that Ethernet communication via the IO module connector 508a. Continuing with the example in which the Ethernet storage system 200 is an EBOF storage system and the storage device 502 in the storage subsystem 406b/500 is an NVMe storage device, the bridge device 506 may be an NVMe-to-Ethernet bridge device that converts an NVMe communication received from the NVMe storage device to an Ethernet communication that includes the data retrieved from the NVMe storage device, and transmits that Ethernet communication via the IO module connector 508a, although the conversion of other storage protocol communications to Ethernet communications will fall within the scope of the present disclosure as well.

With reference to FIGS. 8B and 8C, in an embodiment of block 602, the retimer device 404b may perform data receiving operations 804 that include receiving the Ethernet communication that includes the data retrieved from the storage device 502 via the storage connector 406a (e.g., the “second” storage connector 406b from the “top” of the group of storage connectors 406b in FIG. 8B) that is coupled to the IO module connector 508a on the storage subsystem 206b/500 (e.g., the “second” storage subsystem 206b from the “top” of the group of storage subsystems 206b in FIG. 8C).

The method 600 then proceeds to block 604 where the retimer device performs retimer operations on the Ethernet communications received from the at least one of the subset of the storage subsystems that are coupled to that retimer device. As will be appreciated by one of skill in the art in possession of the present disclosure, the Ethernet communication that includes the data retrieved from the storage device 502 and that is transmitted by the storage subsystem 206b/500 to the IO module 208a will require the performance of the retimer operations by the retimer device 404b described below due to the relatively long distance that Ethernet communication must travel between the IO module 208a and the networking device 210a/300 (e.g., the relatively long distance from the IO module 208a and across multiple rack units in a rack via a cable to the networking device 210a/300 as compared to the relatively short distance that Ethernet communication must travel between the storage subsystem 206b and the IO module 208a via cabling, traces, and/or other couplings in the storage chassis 202), as the bridge device 506 will typically generate the Ethernet communication with a relatively low strength that requires the retimer device 404b to perform the retimer operations on the Ethernet communication that are transmitted to the networking device 210a.

In an embodiment, at block 604 and in response to receiving the Ethernet communication that includes the data retrieved from the storage device 502, the retimer device 404b may perform retimer operations on that Ethernet communication that may include extracting an embedded clock signal from the Ethernet communication for use in synchronizing the timing of the data included in the Ethernet communication, recovering the data included in the Ethernet communication by correcting errors or other data distortions that may have occurred during transmission between the bridge device 506 in the storage subsystem 206b/500 and the retimer device 404b, and/or performing any other retimer operations that would be apparent to one of skill in the art in possession of the present disclosure.

The method 600 then proceeds to block 606 where the retimer device transmits the Ethernet communications to the networking device coupled to that retimer device as part of the retimer operations. With reference to FIGS. 8B and 8C, in an embodiment of block 606 and as part of the retimer operations initiated at block 604, the retimer device 404b may perform data transmission operations 806 that may include transmitting an Ethernet communication that includes the data recovered at block 604 via the networking connector 402b and to the networking device 210a/300 such that the data in that Ethernet communication is received by the networking engine 304 via the communication subsystem 308 and provided by the networking engine 304 via the communication subsystem 308 the computing device that provided the data retrieval request discussed above.

As will be appreciated by one of skill in the art in possession of the present disclosure, the Ethernet communication that includes the data recovered at block 604 may be transmitted by the retimer device 404b using a “clean” clock signal that has reduced noise, jitter, and/or other distortions that may have been present in the clock signal included in the Ethernet communication received by the retimer device 404b from the bridge device 506 in the storage subsystem 206b/500, thus transmitting the Ethernet communication and data recovered at block 604 with reduced noise, jitter, and/or other distortions that may have been present in the Ethernet communication and data received by the retimer device 404b from the bridge device 506 in the storage subsystem 206b/500 and ensuring that Ethernet communication and data transmitted to the networking device 210a is robust, is error-free (or has reduced number of errors), and/or is otherwise in condition for transmission from the IO module 208a to the networking device 210a.

While not described herein in detail, one of skill in the art in possession of the present disclosure will appreciate how data may be stored in the storage subsystems 206a-206b of the Ethernet storage system 200. For example, similarly to the Ethernet communication that includes the data retrieval request described above, the networking device 210a may receive an Ethernet communication that include a data storage request (and corresponding data) and may transmit that Ethernet communication to the IO module 208a such that it is received by one of the retimer devices 404a-404c (i.e., via its corresponding networking connector 402a-402c) that forwards it to the appropriate storage subsystem 206a-206c/500 (i.e., via its corresponding storage connector 406a-406c), with the bridge device 506 in that storage subsystem 500 receiving that Ethernet communication (e.g., via the IO module connector 508a), converting that Ethernet communication to a storage protocol communication, and transmitting that storage protocol communication via the storage interface 502a to the storage device 502 so that that storage controller in that storage device 502 may store the corresponding data provided with that data storage request in that storage device 502.

Thus, systems and methods have been described that provide retimer devices in an IO module to transmit Ethernet communications between storage subsystems and networking devices in an Ethernet storage system. For example, the Ethernet storage system of the present disclosure may include a first networking device, a plurality of storage subsystems, and a first Input/Output (IO) module that is coupled to the first networking device and the plurality of storage subsystems. The first IO module includes a plurality of first retimer devices that each couple a respective subset of the plurality of storage subsystems to the first networking device. Each of the plurality of first retimer devices receives Ethernet communications from at least one of the subset of the plurality of storage subsystems coupled to that first retimer device, and performs retimer operations on the Ethernet communications received from the at least one of the subset of the plurality of storage subsystems coupled to that first retimer device to transmit the Ethernet communications to the first networking device. As such, Ethernet storage systems may be provided with IO modules that are less complex, that use less power, and that cost less than conventional IO modules that utilize Ethernet switch chips and NOSs provided by SoCs and corresponding memory systems.

While one of skill in the art in possession of the present disclosure will recognize that the Ethernet storage system of the present disclosure is primarily described above as being implemented for use with particular communications technologies (e.g., copper (or similar type) cabling) that necessitates the use of the retimer devices discussed above, in other embodiments the retimer devices may be replaced with components that provide similar benefits with other types of communication technologies. For example, for Ethernet storage systems that utilize optical communications technologies (e.g., Fibre Optic (or similar type) cabling), the retimer devices discussed above may be replaced by electrical/optical signal converter devices (e.g., for use with storage subsystems that transmit electrical communication signals), or optical signal transmission devices (e.g., for use with storage subsystems that transmit optical communication signals). Furthermore, if storage subsystems 206a-206c are provided with communication signal generation and transmission capabilities that generate and transmit communication signals with sufficient strength to reach the networking devices 210a and 210b, the retimer devices 404a-404c may be omitted.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An Ethernet storage system, comprising:
a first networking device;
a plurality of storage subsystems; and
a first Input/Output (IO) module that is coupled to the first networking device and the plurality of storage subsystems, wherein the first IO module includes:
a plurality of first retimer devices that each couple a respective subset of the plurality of storage subsystems to the first networking device, wherein each of the plurality of first retimer devices is configured to:
receive Ethernet communications from at least one of the subset of the plurality of storage subsystems coupled to that first retimer device; and
perform retimer operations on the Ethernet communications received from the at least one of the subset of the plurality of storage subsystems coupled to that first retimer device to transmit the Ethernet communications to the first networking device.

2. The system of claim 1, wherein each of the plurality of storage subsystems includes a Solid State Drive (SSD) storage device.

3. The system of claim 2, wherein the SSD storage device included in each of the plurality of storage subsystems is a Non-Volatile Memory express (NVMe) storage device.

4. The system of claim 3, wherein each of the plurality of storage subsystems includes an NVMe-to-Ethernet bridge device.

5. The system of claim 1, wherein an IO-module-to-networking-device bandwidth between the first IO module and the first networking device is equal to an IO-module-to-storage-subsystem bandwidth between the first IO module and the plurality of storage subsystems.

6. The system of claim 1, wherein the first IO module provides a respective connection for each of the plurality of first retimer devices to each of the subset of the plurality of storage subsystems coupled to that first retimer device, and a single connection for each of the plurality of first retimer devices to the first networking device.

7. The system of claim 1, further comprising:
a second networking device; and
a second IO module that is coupled to the second networking device and the plurality of storage subsystems, wherein the second IO module includes:
a plurality of second retimer devices that each couple a respective subset of the plurality of storage subsystems to the second networking device, wherein each of the plurality of second retimer devices is configured to:
receive Ethernet communications from at least one of the subset of the plurality of storage subsystems coupled to that second retimer device; and
perform retimer operations on the Ethernet communications received from the at least one of the subset of the plurality of storage subsystems coupled to that second retimer device to transmit the Ethernet communications to the second networking device.

8. An Input/Output (IO) module, comprising:
an Input/Output (IO) module chassis;
a plurality of first networking device connectors that are included on the IO module chassis;
a plurality of storage connectors that are included on the IO module chassis; and
a plurality of first retimer devices that are included on the IO module chassis and that each couple a respective subset of the plurality of storage connectors to a respective subset of the plurality of first networking device connectors, wherein each of the plurality of first retimer devices is configured to:
receive Ethernet communications via at least one of the subset of the plurality of storage connectors coupled to that first retimer device; and
perform retimer operations on the Ethernet communications received from the at least one of the subset of the plurality of storage connectors coupled to that first retimer device to transmit the Ethernet communications via at least one of the subset of the plurality of first networking device connectors coupled to that first retimer device.

9. The IO module of claim 8, wherein the plurality of storage connectors are configured to couple to a plurality of Solid State Drive (SSD) storage device.

10. The IO module of claim 9, wherein the plurality of storage connectors are configured to couple to a plurality of Non-Volatile Memory express (NVMe) storage devices.

11. The IO module of claim 10, wherein each of the plurality of first retimer devices is configured to receive the Ethernet communications via the at least one of the subset of the plurality of storage connectors that is coupled to that first retimer device and to an NVMe-to-Ethernet bridge device that is connected to one of the plurality of NMVe storage devices.

12. The IO module of claim 8, wherein an IO-module-to-networking-device bandwidth provided by the plurality of first networking device connectors is equal to an IO-module-to-storage-subsystem bandwidth provided by the plurality of storage connectors.

13. The IO module of claim 8, wherein each of the plurality of first retimer devices is configured to be coupled to a respective storage subsystem via each of the subset of the plurality of storage connectors coupled to that first retimer device, and wherein each of the plurality of first retimer devices is configured to be coupled to a first networking device via a one of the plurality of first networking device connectors.

14. A method for storing data in a storage system using an Ethernet network, comprising:
receiving, by a first retimer device that is included on a first Input/Output (IO) module that is coupled to a plurality of storage subsystems and a first networking device, Ethernet communications from at least one of a subset of the plurality of storage subsystems that are coupled to that first retimer device;
performing, by the first retimer device, retimer operations on the Ethernet communications received from the at least one of the subset of the plurality of storage subsystems that are coupled to that first retimer device; and
transmitting, by the first retimer device as part of the retimer operations, the Ethernet communications to the first networking device.

15. The method of claim 14, wherein each of the plurality of storage subsystems includes a Solid State Drive (SSD) storage device.

16. The method of claim 15, wherein the SSD storage device included in each of the plurality of storage subsystems is a Non-Volatile Memory express (NVMe) storage device.

17. The method of claim 16, wherein each of the plurality of storage subsystems includes an NVMe-to-Ethernet bridge device.

18. The method of claim 14, wherein an IO-module-to-networking-device bandwidth between the first IO module and the first networking device is equal to an IO-module-to-storage-subsystem bandwidth between the first IO module and the plurality of storage subsystems.

19. The method of claim 14, wherein the first IO module provides a respective connection for each of the plurality of first retimer devices to each of the subset of the plurality of storage subsystems coupled to that first retimer device, and a single connection for each of the plurality of first retimer devices to the first networking device.

20. The method of claim 14, further comprising:
receiving, by a second retimer device that is included on a second IO module that is coupled to a plurality of storage subsystems and a second networking device, Ethernet communications from at least one of a subset of the plurality of storage subsystems that are coupled to that second retimer device;
performing, by the second retimer device, retimer operations on the Ethernet communications received from the at least one of the subset of the plurality of storage subsystems that are coupled to that second retimer device; and
transmitting, by the second retimer device as part of the retimer operations, the Ethernet communications to the second networking device.
